(19) United States
(12) Patent Application Publication
(10) Pub. No.: US 2022/0341755 A1
(43) Pub. Date: Oct. 27, 2022

(54) ELECTRONIC APPARATUS AND METHOD AND PROGRAM FOR DETERMINING ROTATIONAL MOVEMENT STATE OF ROTATIONAL MOVEMENT MEMBER

(71) Applicant: FUJIFILM Corporation, Tokyo (JP)

(72) Inventor: Kenshi IMAMURA, Saitama-shi (JP)

(73) Assignee: FUJIFILM Corporation, Tokyo (JP)

(21) Appl. No.: 17/860,580

(22) Filed: Jul. 8, 2022

Related U.S. Application Data
(63) Continuation of application No. PCT/JP2021/005120, filed on Feb. 10, 2021.

(30) Foreign Application Priority Data
Feb. 17, 2020 (JP) 2020-024395

(51) Int. Cl. G01D 5/14; H04N 5/225

(52) U.S. Cl. CPC G01D 5/142; H04N 5/225251

(57) ABSTRACT

An electronic apparatus includes: a body; a rotational movement member that is rotationally movable with respect to the body in a first rotational movement direction about a first rotational axis and a second rotational movement direction about a second rotational axis; a magnetic field generator; a first magnetic field detection element that detects a magnetic field generated from the magnetic field generator; a second magnetic field detection element that detects the magnetic field generated from the magnetic field generator; and a processor that determines which one of first, second and third states a rotational movement state of the rotational movement member is based on detection states of the magnetic field detected by the first magnetic field detection element and the second magnetic field detection element, and a detection surface of the second magnetic field detection element is parallel to the imaginary plane in the state defined herein.

### CROSS REFERENCE TO RELATED APPLICATION

This is a continuation of International Application No. PCT/JP2021/005120 filed on Feb. 10, 2021, and claims priority from Japanese Patent Application No. 2020-024395 filed on Feb. 17, 2020, the entire disclosures of which are incorporated herein by reference.

### BACKGROUND OF THE INVENTION

### 1. Field of the Invention

The present invention relates to an electronic apparatus and a method and computer readable medium storing program for determining the rotational movement state of a rotational movement member.

### 2. Description of the Related Art

JP2018-072429A discloses an electronic apparatus that can detect the state of a display unit using a magnetic sensor, has a small size, and is easily assembled. The electronic apparatus includes a display unit that is rotationally movable with respect to a body part in a first direction about a first axis and a second direction about a second axis, a magnet that generates a magnetic field, a first sensor that detects a first state of the display unit in the first direction on the basis of the magnetic field, a second sensor that detects a second state of the display unit in the second direction on the basis of the magnetic field, a third sensor that detects a third state of the display unit on the basis of the magnetic field, and a controller that controls a display state of the display unit on the basis of the first state, the second state, and the third state. JP2016-138950A discloses an electronic apparatus which comprises a movable display unit and in which the opening/closing of the display unit is magnetically detected without an increase in size and the design of an opening/closing detection angle is facilitated. The electronic apparatus comprises a movable part that allows the display unit to be rotationally movable with respect to an apparatus body part in an opening/closing direction by a hinge unit. A magnet is disposed near the hinge unit, and an opening/closing sensor detects the magnetic field of the magnet to detect the opening/closing of the movable part. The magnetization direction of the magnet is a direction perpendicular to the opening/closing axis of the movable part, the opening/closing sensor detects a magnetic field perpendicular to the opening/closing axis, and the controller acquires the detection signal of the opening/closing sensor to control the display state of the display unit.

### SUMMARY OF THE INVENTION

An object of the present invention is to provide an electronic apparatus that determines the rotational movement state of a rotational movement member and a method and a computer readable medium storing a program for determining the rotational movement state of the rotational movement member.

An electronic apparatus according to an aspect of the present invention comprises a body, a rotational movement member that is rotationally movable with respect to the body in a first rotational movement direction about a first rotational axis and a second rotational movement direction about a second rotational axis, a magnetic field generator, a first magnetic field detection element that detects a magnetic field generated from the magnetic field generator, a second magnetic field detection element that detects the magnetic field generated from the magnetic field generator, and a processor that determines which one of a first state, a second state, and a third state a rotational movement state of the rotational movement member is on the basis of detection states of the magnetic field detected by the first magnetic field detection element and the second magnetic field detection element. In a state where an imaginary plane parallel to a detection surface of the first magnetic field detection element is rotated about a first axis extending in a first direction and a second axis extending in a second direction intersecting with the first direction, a detection surface of the second magnetic field detection element is parallel to the imaginary plane. Both of the first direction and the second direction are directions along the imaginary plane, the first direction is an extending direction of the first rotational axis, and the second direction is an extending direction of the second rotational axis.

A method of determining a rotational movement state of a rotational movement member according to another aspect of the present invention is a method of determining a rotational movement state of a rotational movement member of an electronic apparatus including a body, the rotational movement member that is rotationally movable with respect to the body in a first rotational movement direction about a first rotational axis and a second rotational movement direction about a second rotational axis, a magnetic field generator, a first magnetic field detection element that detects a magnetic field generated from the magnetic field generator, and a second magnetic field detection element that detects the magnetic field generated from the magnetic field generator. In a state where an imaginary plane parallel to a detection surface of the first magnetic field detection element is rotated about a first axis extending in a first direction and a second axis extending in a second direction intersecting with the first direction, a detection surface of the second magnetic field detection element is parallel to the imaginary plane. Both of the first direction and the second direction are directions along the imaginary plane, the first direction is an extending direction of the first rotational axis, the second direction is an extending direction of the second rotational axis, and the method comprises determining which one of a first state, a second state, and a third state a rotational movement state of the rotational movement member is on the basis of detection states of the magnetic field detected by the first magnetic field detection element and the second magnetic field detection element.

A program for determining a rotational movement state of a rotational movement member according to another aspect of the present invention is a program for determining a rotational movement state of a rotational movement member of an electronic apparatus including a body, the rotational movement member that is rotationally movable with respect to the body in a first rotational movement direction about a first rotational axis and a second rotational movement direction about a second rotational axis, a magnetic field generator, a first magnetic field detection element that detects a magnetic field generated from the magnetic field generator, and a second magnetic field detection element that detects the magnetic field generated from the magnetic field generator. In a state where an imaginary plane parallel to a detection surface of the first magnetic field detection element is rotated about a first axis extending in a first direction and a second axis extending in a second direction intersecting with the first direction, a detection surface of the second magnetic field detection element is parallel to the imaginary plane. Both of the first direction and the second direction are directions along the imaginary plane, the first direction is an extending direction of the first rotational axis, the second direction is an extending direction of the second rotational axis, and the program causes a processor to perform a step of determining which one of a first state, a second state, and a third state a rotational movement state of the rotational movement member is on the basis of detection states of the magnetic field detected by the first magnetic field detection element and the second magnetic field detection element.

### BRIEF DESCRIPTION OF THE DRAWINGS

FIG. 1 is a rear view showing an example of an imaging apparatus that is used to describe an electronic apparatus according to an embodiment of the present invention, and is a diagram showing a first state where a rotational movement member of the imaging apparatus is closed in a body part.

FIG. 2 is a rear view showing the rotational movement state (second state) of the rotational movement member of the imaging apparatus shown in FIG. 1.

FIG. 3 is a rear view showing the rotational movement state (third state) of the rotational movement member of the imaging apparatus shown in FIG. 1.

FIG. 4 is a rear view showing the rotational movement state (fourth state) of the rotational movement member of the imaging apparatus shown in FIG. 1.

FIG. 5 is a rear view illustrating the configuration of a hinge unit, a first hall element, a second hall element, and a magnet shown in FIG. 1.

FIG. 6 is a top view illustrating the configuration of the hinge unit, the first hall element, the second hall element, and the magnet shown in FIG. 5.

FIG. 7 is a side view illustrating the configuration of the hinge unit, the first hall element, the second hall element, and the magnet shown in FIG. 5.

FIG. 8 is a schematic diagram illustrating an arrangement relationship between the first hall element and the second hall element shown in FIG. 5.

FIG. 9 is a schematic diagram illustrating an arrangement relationship between the first hall element and the second hall element shown in FIG. 5.

FIG. 10 is a schematic diagram illustrating an arrangement relationship between the first hall element and the second hall element shown in FIG. 5.

FIG. 11 is a graph illustrating a change in a magnetic flux density that is detected by the first hall element in a case where the rotational movement member is rotationally moved to the first state from the second state.

FIG. 12 is a graph illustrating a change in a magnetic flux density that is detected by the second hall element in a case where the rotational movement member is rotationally moved to the first state from the second state.

FIG. 13 is a graph illustrating a change in a magnetic flux density that is detected by the first hall element in a case where the rotational movement member is rotationally moved to the third state from the second state.

FIG. 14 is a graph illustrating a change in a magnetic flux density that is detected by the second hall element in a case where the rotational movement member is rotationally moved to the third state from the second state.

### DESCRIPTION OF THE PREFERRED EMBODIMENTS

An electronic apparatus and a method and program for determining the rotational movement state of a rotational movement member according to a specific embodiment (hereinafter, referred to as “this embodiment”.) of the present invention will be described below with reference to the respective drawings.

An imaging apparatus, such as a mirrorless camera, will be described in this embodiment as an example of the electronic apparatus according to the embodiment of the present invention, but the electronic apparatus is not limited thereto. Various technical ideas of the present invention can be appropriately applied to any electronic apparatus of which a rotational movement member, such as a display unit, is adapted to be rotationally movable about a predetermined rotational axis with respect to a body part.

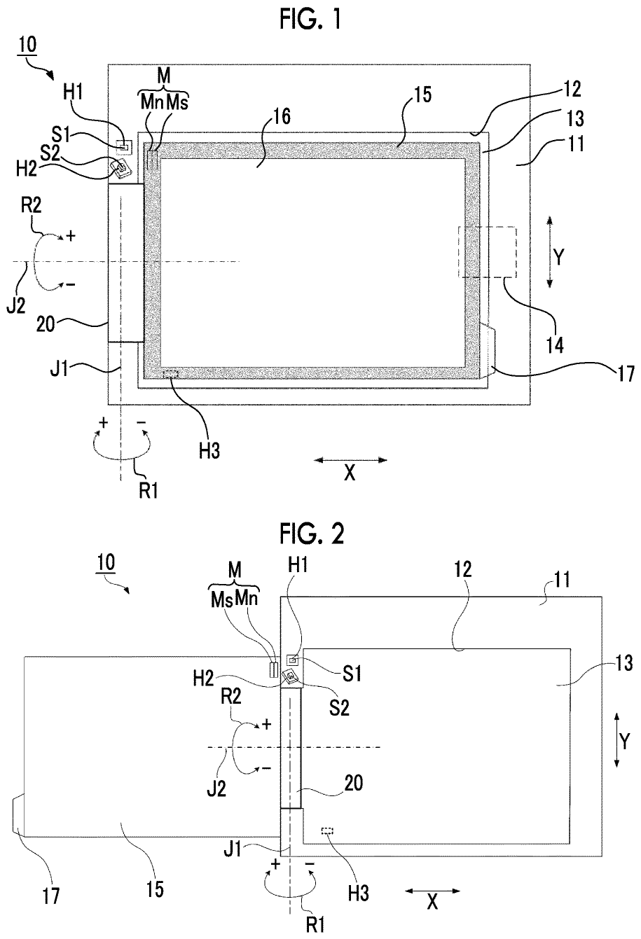

Further, in the following description, each drawing shall be viewed according to the orientation of the reference numerals. Furthermore, a front side or a front surface side is defined as the back side of the plane of paper of FIG. 1, a rear side or a rear surface side is defined as the front side of the plane of paper of FIG. 1, an upper side is defined as the upper side of the plane of paper of FIG. 1, a lower side is defined as the lower side of the plane of paper of FIG. 1, a left side is defined as the left side of the plane of paper of FIG. 1, and a right side is defined as the right side of the plane of paper of FIG. 1. Moreover, the front side is a side that faces an object to be imaged by the imaging apparatus. Further, a front-rear direction and a left-right direction are parallel to a horizontal plane, and an up-down direction is parallel to a vertical direction (the direction of gravity) orthogonal to the horizontal plane. In the respective drawings, an X direction is parallel to the left-right direction, a Y direction is parallel to the up-down direction, and a Z direction is parallel to the front-rear direction.

[As for Basic Configuration of Imaging Apparatus]

The basic configuration of an imaging apparatus 10 according to this embodiment will be described first with reference to FIG. 1. FIG. 1 is a rear view showing an example of an imaging apparatus 10 that is used to describe this embodiment, and is a diagram showing a first state where a display unit 15 forming a rotational movement member is closed in a body part 11. The body part 11 forms a body.

As shown in FIG. 1, the imaging apparatus 10 includes a substantially box-shaped body part 11, a substantially cylindrical imaging lens unit (not shown) that is attachably and detachably mounted on the front side of the body part 11, and a substantially flat plate-shaped display unit 15 that is provided on the rear surface side of the body part 11 and is integrally mounted to be rotationally movable. The imaging lens unit includes a plurality of lenses arranged in parallel therein and is increased and reduced in length in the front-rear direction to adjust distances between the lenses, so that the imaging lens unit focuses on an object to be imaged. The imaging apparatus 10 further includes an imaging element, digitally converts light, which is incident through the imaging lens unit, by the imaging element, and records and holds imaging results.

A plurality of operation button parts or an operation dial part (not shown) is provided on the upper surface side of the body part 11. Further, a grip portion (not shown) bulging forward is provided at the right end portion of the front side of the body part 11. An operator can stably grip and operate the imaging apparatus 10 by gripping this grip with, for example, the right hand. A housing recessed portion 12 of which a bottom surface 13 is formed to be flat is formed on the rear surface side of the body part 11. The bottom surface 13 of the housing recessed portion 12 faces the front surface or back surface of the display unit 15 in a case where the display unit 15 is housed in the housing recessed portion 12.

Further, in this embodiment, a third hall element H3, which is used to detect a magnetic field generated from a magnet M to be described later, is embedded in the lower left portion of a region, which faces the display unit 15 in a case where the display unit 15 is housed, of the bottom surface 13 of the housing recessed portion 12. Furthermore, a processor 14 is built in the body part 11. The processor 14 is formed of various processors. The various processors include, for example, a central processing unit (CPU) that is a general-purpose processor functioning as various processing units by executing software (programs), a programmable logic device (PLD) that is a processor of which circuit configuration can be changed after manufacture, such as a field programmable gate array (FPGA), a dedicated electrical circuit that is a processor having circuit configuration designed exclusively to perform specific processing, such as an application specific integrated circuit (ASIC), and the like. The processor 14 may be formed of one of the various processors, or may be formed of a combination of two or more processors of the same type or different types (for example, a plurality of FPGAs or a combination of a CPU an FPGA). The hardware structures of these various processors are more specifically electrical circuitry where circuit elements, such as semiconductor elements, are combined. Programs to be executed by the processor 14 include a program for determining which one of a first state, a second state, a third state, and a fourth state to be described later the rotational movement state of the display unit 15 is.

The display unit 15 includes a display panel 16 on the surface side (one surface) thereof and can function as a rear display of the imaging apparatus 10. The taken image of an object to be imaged, an operation panel, or the like is appropriately displayed on the display panel 16 of the display unit 15. Further, a hinge unit 20 is provided at the left portion of the display unit 15. The hinge unit 20 is adapted to have a first rotational axis J1 and a second rotational axis J2, and the display unit 15 is mounted on the body part 11 through the hinge unit 20 to be rotationally movable. Specifically, the display unit 15 is supported by the body part 11 through the hinge unit 20 to be rotationally movable with respect to the body part 11 in a first rotational movement direction R1 about the first rotational axis J1 and a second rotational movement direction R2 about the second rotational axis J2.

A finger hook portion 17, which is formed to protrude outward, is provided at the lower portion of an end portion of the display unit 15 opposite to the hinge unit 20. An operator makes an index finger or the like be caught by the finger hook portion 17 to open and close the display unit 15 in the left-right direction or to rotate the display unit 15 in the up-down direction.

The first rotational axis J1 of the hinge unit 20 is parallel to the up-down direction (Y direction). That is, the first rotational movement direction R1 is the opening/closing direction of the display unit 15 in the left-right direction with respect to the body part 11. The second rotational axis J2 of the hinge unit 20 is parallel to the left-right direction (X direction). That is, the second rotational movement direction R2 is the rotation direction of the display unit 15 in the up-down direction with respect to the body part 11. Further, the first rotational axis J1 and the second rotational axis J2 are disposed to be orthogonal to each other.

A first hall element H1 and a second hall element H2 are built in the body part 11. The first hall element H1 and the second hall element H2 are disposed from the upper end portion of the hinge unit 20 to be spaced from each other along the upper portion of the first rotational axis J1. As described later, a first detection surface S1 of the first hall element H1 and a second detection surface S2 of the second hall element H2 are disposed to intersect with each other. That is, a normal vector to the first detection surface S1 of the first hall element H1 and a normal vector to the second detection surface S2 of the second hall element H2 are provided not to be parallel to each other. Further, the display unit 15 is provided with a magnet M (magnetic field generator). Specifically, the magnet M is embedded in the upper left end portion of the display unit 15 to be close to the first hall element H1 and the second hall element H2 in the left-right direction (X direction) in a state where the display panel 16 of the display unit 15 is disposed to be exposed to the rear surface side of the body part 11 and the display unit 15 is housed in the housing recessed portion 12 of the body part 11 (that is, a first state to be described later). The magnet M is disposed so that the orientation of the magnetic field of the magnet M is parallel to the left-right direction. Specifically, a left portion Mn of the magnet M is provided to correspond to an N pole, and a right portion Ms thereof is provided to correspond to an S pole.

The first hall element H1 detects a magnetic field generated from the magnet M to grasp the open/closed state of the display unit 15 in the left-right direction (X direction). The second hall element H2 detects a magnetic field generated from the magnet M to grasp the rotational state of the display unit 15 in the up-down direction (Y direction). The third hall element H3 detects a magnetic field generated from the magnet M to grasp the housing state of the display unit 15. The above-mentioned processor 14 determines which one of the first state, the second state, the third state, and the fourth state to be described later the rotational movement state of the display unit 15 is on the basis of the detection states of a magnetic field detected by the first hall element H1, the second hall element H2, and the third hall element H3.

[As for Rotational Movement State of Rotational Movement Member]

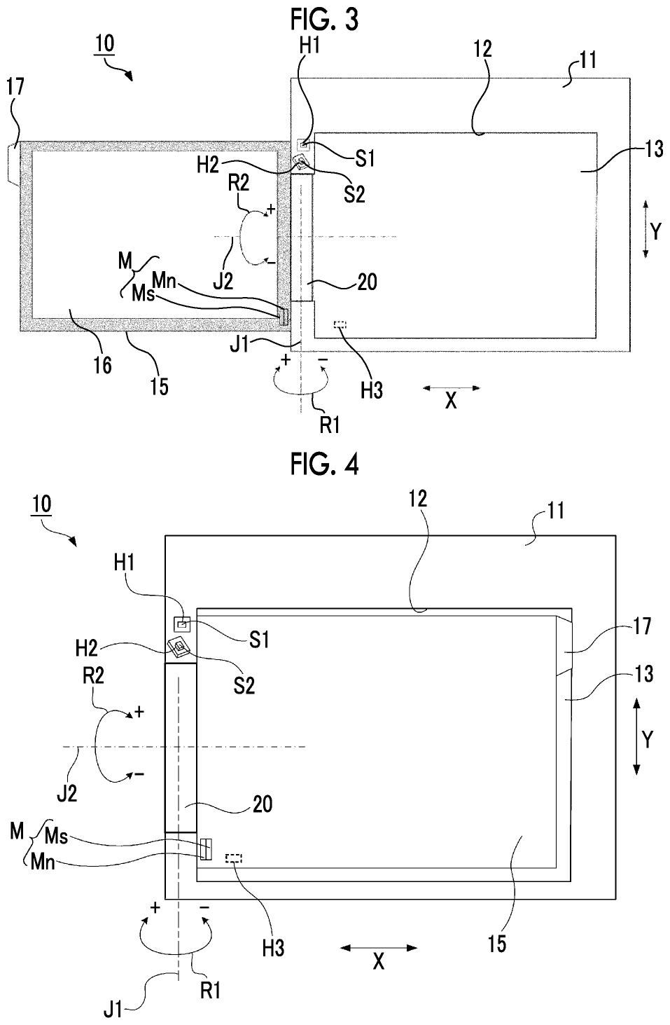

Next, a plurality of rotational movement states (first to fourth states) in a case where the display unit 15 of the imaging apparatus 10 is operated to be opened or closed, or rotated will be described with reference to FIG. 1 and FIGS. 2 to 4. FIG. 2 is a rear view showing the second state where the display unit 15 of the imaging apparatus 10 is opened with respect to the body part 11. FIG. 3 is a rear view showing the third state where the display unit 15 of the imaging apparatus 10 is rotated with respect to the body part 11 from the state shown in FIG. 2. FIG. 4 is a rear view showing the fourth state where the display unit 15 of the imaging apparatus 10 is closed with respect to the body part 11 from the state shown in FIG. 3.

In the following description, with regard to a rotational movement state indicating each of the opening/closing and rotation of the display unit 15, a state where the display unit 15 is housed in the housing recessed portion 12 and the display panel 16 of the display unit 15 is exposed to the rear surface side as shown in FIG. 1, that is, a state where the display unit 15 is closed with respect to the body part 11 is referred to as the first state as the initial state of the rotational movement state. It is defined that an opening/closing angle about the first rotational axis J1 is 0° and a rotation angle about the second rotational axis J2 is 0° in this first state. Further, the positive and negative (plus and minus) directions of these rotational movement angles depend on the indication of + (plus) and − (minus) in each drawing. Further, in this embodiment, the upper limit of the opening/closing angle is set to 180° in the + direction and the lower limit thereof is set to 180° in the − direction. The upper limit of the rotation angle is set to 180° in the + direction and the lower limit thereof is set to 180° in the − direction.

FIG. 1 shows the first state. As shown in FIG. 1, in the first state, the display unit 15 is closed in the left-right direction and is housed in the housing recessed portion 12 of the body part 11. In this first state, an opening/closing angle about the first rotational axis J1 is 0° and a rotation angle about the second rotational axis J2 is 0°. Further, in this first state, the magnet M is disposed close to the first hall element H1 and the second hall element H2. For this reason, the first hall element H1 and the second hall element H2 detect a magnetic field generated from the magnet M. On the other hand, the magnet M is disposed to be spaced from the third hall element H3. For this reason, the magnetic flux density of a magnetic field, which is generated from the magnet M, detected by the third hall element H3, is low and is equal to or lower than a predetermined threshold value.

In the first state, the display panel 16 of the display unit 15 is disposed to face a side opposite to the body part 11. The processor 14 determines the first state on the basis of the detection states of a magnetic field detected by the first hall element H1, the second hall element H2, and the third hall element H3, and causes the display panel 16 of the display unit 15 to be in a state where the display panel 16 can be turned on on the basis of the result of this determination. Accordingly, an operator can directly visually recognize the display information of the display panel 16 on the rear surface side of the body part 11 while gripping the body part 11 of the imaging apparatus 10 with a hand (hereinafter, the display state of the display panel 16 of the display unit 15 at this time is also referred to as “normal display”).

In a case where the plurality of operation button parts or the operation dial part provided on the upper surface side of the body part 11 is operated by an operator in this first state, the processor 14 determines whether or not to turn on the display panel 16 of the display unit 15 in the first state even on the basis of the operation state of the operation button parts or the operation dial part.

In a case where the display unit 15 is opened in the + (plus) direction of the first rotational movement direction R1 (the opening/closing direction, the left-right direction in FIG. 1) about the first rotational axis J1 from the first state, the magnetic flux density detected by the first hall element H1 and the second hall element H2 is changed with the rotational movement of the display unit 15. Further, the magnetic flux density detected by the third hall element H3 at this time is still low and is not changed much. The processor 14 perceives that the display unit 15 is opened on the basis of the detection states of a magnetic field detected by the first hall element H1, the second hall element H2, and the third hall element H3, and continues to turn on, for example, the display panel 16 of the display unit 15. In a case where an operator continues to further perform an operation for rotationally moving the display unit 15 in the + (plus) direction about the first rotational axis J1 from the first state, the rotational movement state of the display unit 15 is changed (proceeds) to the second state shown in FIG. 2.

The second state is a state where the display unit 15 is completely opened with respect to the body part 11 as shown in FIG. 2. Specifically, the second state is a state where the display unit 15 is rotationally moved with respect to the body part 11 to the maximum in the + (plus) direction of the first rotational movement direction R1 about the first rotational axis J1, that is, a state where the display unit 15 is opened about the first rotational axis J1. In this second state, an opening/closing angle about the first rotational axis J1 is 180° and a rotation angle about the second rotational axis J2 is 0°.

Further, in a case where an operator performs an operation for rotationally moving the display unit 15 in the + (plus) direction about the first rotational axis J1 from the first state shown in FIG. 1, the magnet M is disposed to be spaced from the third hall element H3 as described above. Furthermore, since the magnetic flux densities of a magnetic field, which is generated from the magnet M, detected by the first hall element H1 and the second hall element H2 are changed with the operation for rotationally moving the display unit 15, the processor 14 comprehensively perceives a change in these magnetic flux densities of a magnetic field over time and determines the rotational movement state of the display unit 15.

In a case where the rotational movement state of the display unit 15 is changed to the second state from the first state, the display panel 16 of the display unit 15 is disposed on the front side of the body part 11 (on the back side of the plane of paper in FIG. 2) but the display panel 16 of the display unit 15 is in the normal display. For this reason, a display on the display panel 16 of the display unit 15 is a so-called mirror image display, which is suitable for an operator to take a selfie.

In a case where an operator performs an operation for rotationally moving the display unit 15 in the + (plus) direction about the second rotational axis J2 from the second state shown in FIG. 2, the display unit 15 is turned over about the second rotational axis J2 and the rotational movement state of the display unit 15 is changed to the third state shown in FIG. 3. Due to this change, the display panel 16 of the display unit 15 is disposed on the rear surface side of the body part 11.

The third state is a state where the display unit 15 is opened and rotated with respect to the body part 11 as shown in FIG. 3. Specifically, the third state is a state where the display unit 15 is rotationally moved with respect to the body part 11 to the maximum in the + (plus) direction of the first rotational movement direction R1 about the first rotational axis J1 and is rotationally moved to the maximum in the + (plus) direction of the second rotational movement direction R2 about the second rotational axis J2 from the initial state shown in FIG. 1. That is, the third state is a state where the display unit 15 is opened about the first rotational axis J1 and turned over about the second rotational axis J2. In this third state, an opening/closing angle about the first rotational axis J1 is 180° and a rotation angle about the second rotational axis J2 is 180°.

Likewise, even during the change of the rotational movement state of the display unit 15 from the second state to the third state, the first hall element H1 and the second hall element H2 detect a change in the magnetic flux of a magnetic field generated from the magnet M. In this case, the magnet M is moved to be spaced from both the first hall element H1 and the second hall element H2. For this reason, the magnetic flux densities detected by the first hall element H1 and the second hall element H2 are reduced. The processor 14 comprehensively perceives these detection states of a magnetic field generated from the magnet M, and determines that the rotational movement state of the display unit 15 is the third state. Further, in the third state, the display panel 16 of the display unit 15 is disposed on the rear surface side of the body part 11. For this reason, the processor 14 performs conversion processing for reversing the display state of the display panel 16 of the display unit 15 upside down from the normal display on the basis of the result of the determination of the third state, and causes the display panel 16 of the display unit 15 to display an image and the like subjected to the conversion processing. Due to this display, an image and the like are displayed on the display panel 16 of the display unit 15 so that an operator can easily visually recognize the image and the like even in a case where the display unit 15 is turned over about the second rotational axis J2.

In a case where an operator performs an operation for rotationally moving the display unit 15 in the − (minus) direction about the first rotational axis J1 from the third state shown in FIG. 3, the display unit 15 is closed about the first rotational axis J1 and the rotational movement state of the display unit 15 is changed to the fourth state shown in FIG. 4. Due to this change, the display unit 15 is housed in the housing recessed portion 12 in a state where the display panel 16 faces the bottom surface 13 of the housing recessed portion 12 of the body part 11.

As shown in FIG. 4, the fourth state is a state where the display unit 15 is rotated and closed with respect to the body part 11. Specifically, the fourth state is a state where the display unit 15 is rotationally moved to the maximum in the + (plus) direction of the second rotational movement direction R2 about the second rotational axis J2 and is rotationally moved with respect to the body part 11 to the maximum in the − (minus) direction of the first rotational movement direction R1 about the first rotational axis J1 from the second state shown in FIG. 2. That is, the fourth state is a state where the display unit 15 is turned over about the second rotational axis J2 and is completely closed about the first rotational axis J1. In this fourth state, an opening/closing angle about the first rotational axis J1 is 0° and a rotation angle about the second rotational axis J2 is 180°.

Since the magnet M is disposed to be spaced from both the first hall element H1 and the second hall element H2 in the fourth state, the magnetic flux densities of a magnetic field, which is generated from the magnet M, detected by the first hall element H1 and the second hall element H2 are low and are equal to or lower than a predetermined threshold value. On the other hand, likewise, even during the change of the rotational movement state of the display unit 15 from the third state to the fourth state, the third hall element H3 detects a change in the magnetic flux of a magnetic field generated from the magnet M. In this case, the magnet M is moved to be close to the third hall element H3. That is, it is difficult for the first hall element H1 and the second hall element H2 to detect a magnetic field generated from the magnet M, and only the third hall element H3 can detect the magnetic field of the magnet M at a predetermined angle. The processor 14 comprehensively perceives the respective detection states of the magnetic field of the magnet M, and determines that the rotational movement state of the display unit 15 is the fourth state. Further, in the fourth state, the display panel 16 of the display unit 15 is disposed to face the bottom surface 13 of the housing recessed portion 12 of the body part 11. For this reason, in a case where the processor 14 determines that the rotational movement state of the display unit 15 is the fourth state, the processor 14 turns off the display panel 16 of the display unit 15.

As described above, the processor 14 of the imaging apparatus 10 determines which one of the first state, the second state, the third state, and the fourth state the rotational movement state of the display unit 15 is on the basis of the detection states of a magnetic field detected by the first hall element H1, the second hall element H2, and the third hall element H3. Further, this determination program is stored and held in a storage holding unit (not shown) of the imaging apparatus 10 as a program for determining a rotational movement state. The processor 14 appropriately reads the program for determining the rotational movement state from the storage holding unit of the imaging apparatus 10 and executes the program.

[As for Configuration of Hinge Unit and Arrangement Relationship Between First Hall Element and Second Hall Element]

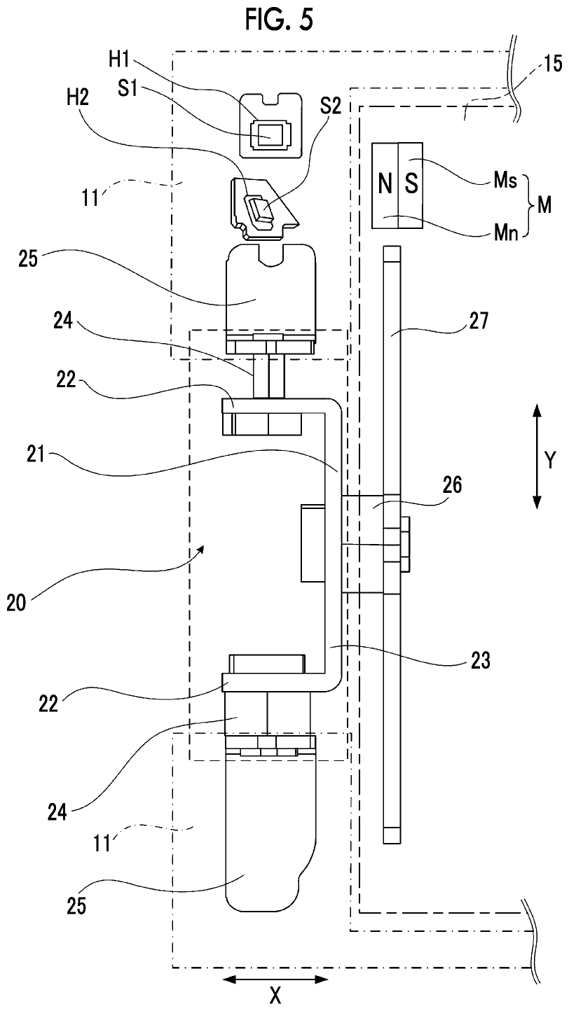

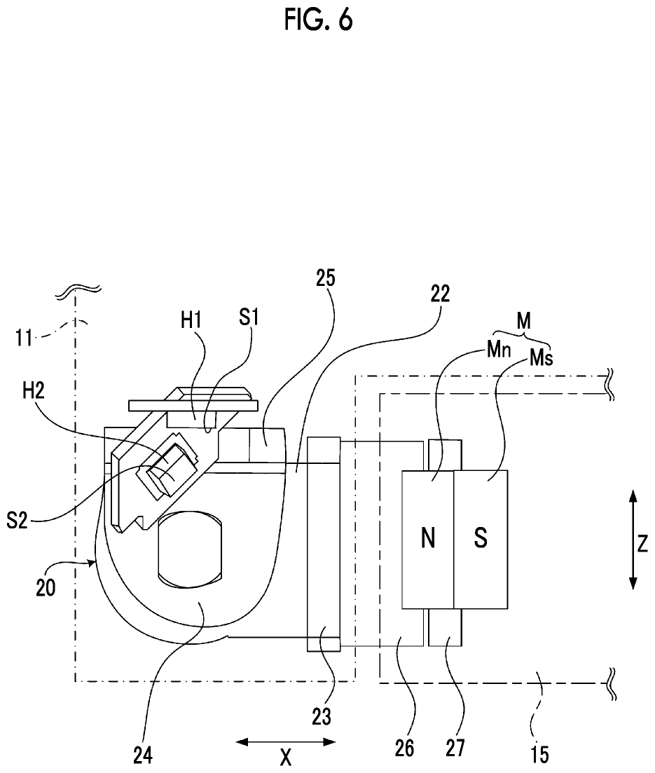

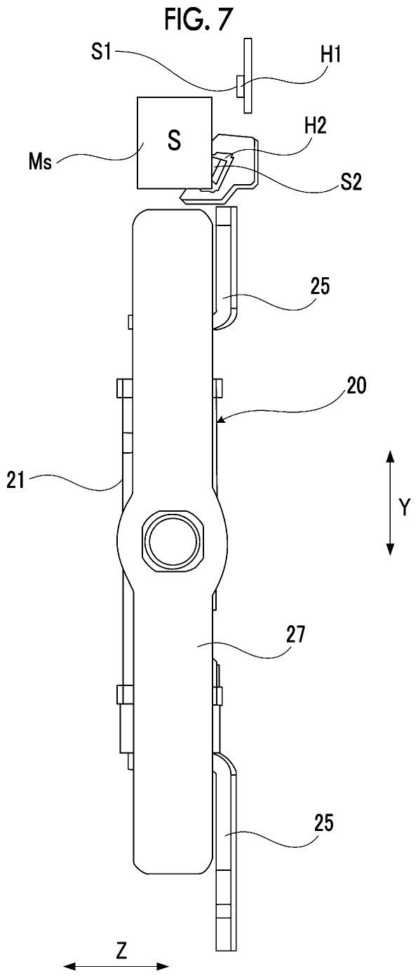

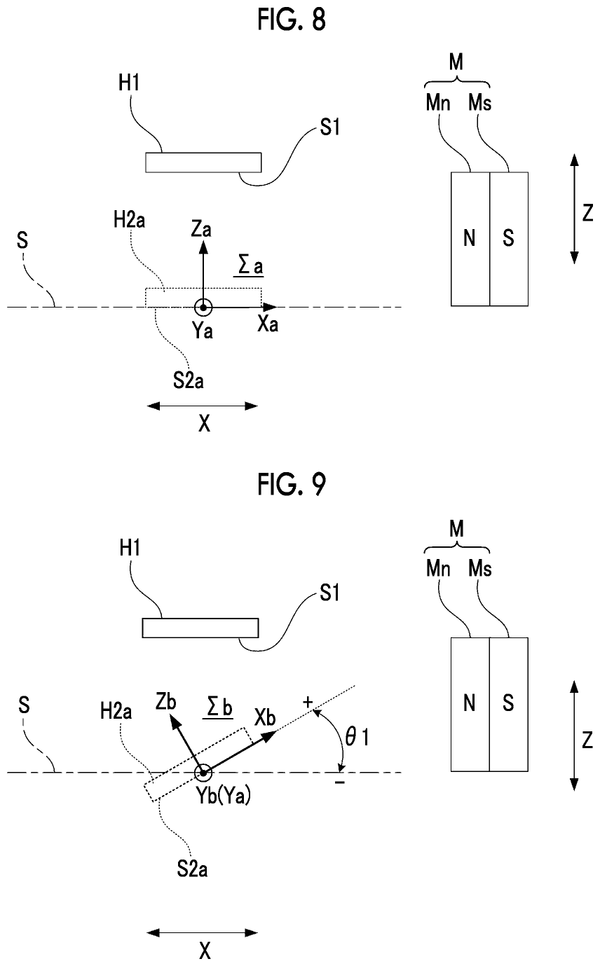

Next, the configuration of the hinge unit 20 and an arrangement relationship between the first hall element H1 and the second hall element H2 will be described with reference to FIGS. 5 to 8. FIG. 5 is a rear view illustrating the configuration of the hinge unit 20, the first hall element H1, the second hall element H2, and the magnet M shown in FIG. 1. FIG. 6 is a top view illustrating the configuration of the hinge unit 20, the first hall element H1, the second hall element H2, and the magnet M shown in FIG. 5. FIG. 7 is a side view illustrating the configuration of the hinge unit 20, the first hall element H1, the second hall element H2, and the magnet M shown in FIG. 5. FIGS. 8 to 10 are schematic diagrams illustrating an arrangement relationship between the first hall element H1 and the second hall element H2.

As shown in FIGS. 5 to 7, the hinge unit 20 includes a base part 21 that is formed to have a U-shaped cross-section in a plan view, a pair of first shaft parts 24 that is held by the base part 21 to be rotationally movable about the first rotational axis J1, and a second shaft part 26 that is held by the base part 21 to be rotationally movable about the second rotational axis J2.

The base part 21 includes a pair of side wall portions 22 that is disposed to be spaced from each other and to face each other in the direction of the first rotational axis J1 and a connecting portion 23 that connects end portions of the pair of side wall portions 22. The first shaft parts 24 are held by the side wall portions 22, respectively, and a first fixing plate part 25 is provided at the distal end portion of each of the first shaft parts 24. The first fixing plate parts 25 are fixed to the body part 11. Due to this fixing, the base part 21 of the hinge unit 20 is rotationally movable about the first rotational axis J1. Further, the connecting portion 23 is provided to extend in the direction of the first rotational axis J1, and a second shaft part 26 is provided at an intermediate portion of the connecting portion 23 in the direction of the first rotational axis J1. A long second fixing plate part 27 is provided at the distal end portion of the second shaft part 26. The second fixing plate part 27 is connected to the second shaft part 26 at an intermediate portion in the longitudinal direction thereof, and is fixed to the display unit 15. Due to this fixing, the display unit 15 is rotationally movable with respect to the body part 11 through the hinge unit 20 in the first rotational movement direction R1 about the first rotational axis J1 and the second rotational movement direction R2 about the second rotational axis J2.

The first hall element H1 and the second hall element H2 are disposed on the upper side of the hinge unit 20 in the direction of the first rotational axis J1 to be spaced from each other. The first hall element H1 is disposed on the upper side of the second hall element H2 in the direction of the first rotational axis J1. That is, the first hall element H1 is provided on the upper side and the second hall element H2 is disposed on the lower side in the direction of the first rotational axis J1. Both of the first hall element H1 and the second hall element H2 are formed in the shape of a flat plate, and the surfaces of the first hall element H1 and the second hall element H2 are the first detection surface S1 and the second detection surface S2 that detect a magnetic field generated from the magnet M, respectively. The first detection surface S1 of the first hall element H1 and the detection surface of the second hall element H2 are disposed to intersect with each other.

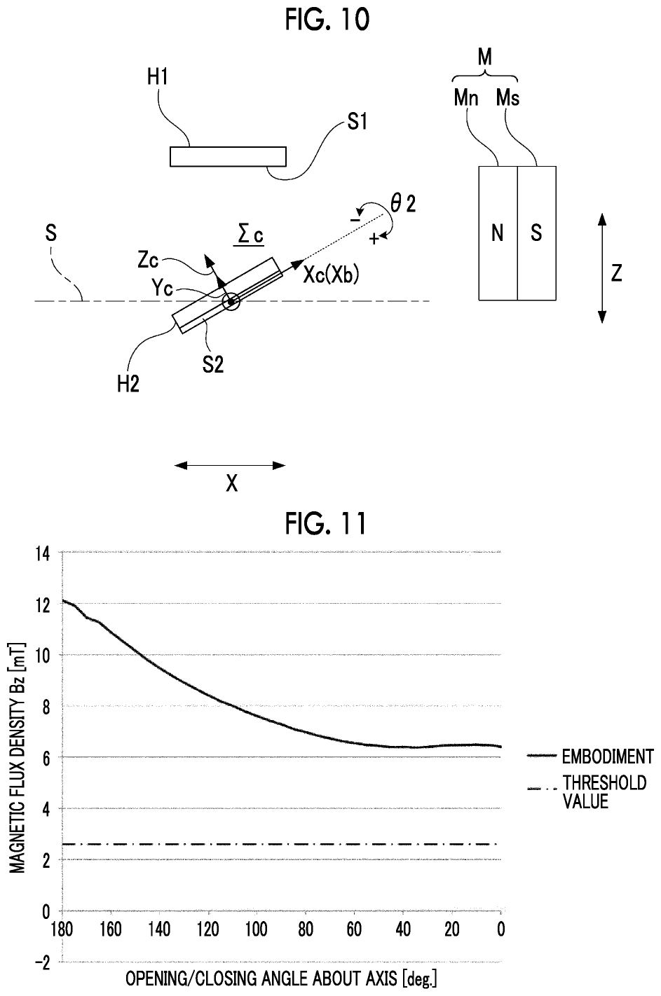

Here, a coordinate system Σa is set in an imaginary plane S parallel to the first detection surface S1 of the first hall element H1 as shown in FIG. 8. Further, as shown in FIGS. 9 and 10, this coordinate system Σa is gradually rotated to set a coordinate system Σb and a coordinate system Σc. The orientation (attitude) of the second detection surface S2 of the second hall element H2 will be described using the coordinate system Σa, the coordinate system Σb, and the coordinate system Σc.

The imaginary plane S is parallel to the first detection surface S1 of the first hall element H1 as described above, and is set to pass through the central point of the second detection surface S2 of the second hall element H2. A second hall element H2a having a second detection surface S2a coinciding with the imaginary plane S is shown in FIG. 8 as a reference.

The coordinate system Σa is to define the attitude of the imaginary plane S. The coordinate system Σa is set in the imaginary plane S and both of an Xa axis and a Ya axis correspond to directions along the imaginary plane S. Further, the Xa axis corresponds to the extending direction of the second rotational axis J2 and is parallel to the X direction. The Ya axis corresponds to the extending direction of the first rotational axis J1 and is parallel to the Y direction. A Za axis is orthogonal to the Xa axis and the Ya axis and is parallel to the Z direction.

The imaginary plane S is parallel to the first detection surface S1 of the first hall element H1, and both of the Xa axis and the Ya axis correspond to directions along the imaginary plane S. For this reason, as a result, a perpendicular line to the first detection surface S1 of the first hall element H1 is orthogonal to the first rotational axis J1 and the second rotational axis J2. The second detection surface S2 of the second hall element H2 is parallel to a plane that is obtained in a case where the imaginary plane S is rotated about the Xa axis and the Ya axis of the coordinate system Σa at predetermined angles.

The origin of each of the coordinate system Σa, the coordinate system Σb, and the coordinate system Σc is set to coincide with the central point of the second detection surface S2 of the second hall element H2. All of the coordinate system Σa, the coordinate system Σb, and the coordinate system Σc are right-handed coordinate systems, and the positive and negative thereof depend on the right-handed system thereof.

First, as shown in FIG. 9, the coordinate system Σa is rotated about the Ya axis in the + (plus) direction by θ1 [°]. The coordinate system rotated by θ1 [°] is the coordinate system Σb. An Xb axis of the coordinate system Σb corresponds to an axis that is obtained in a case where the Xa axis of the coordinate system Σa is rotated. A Yb axis of the coordinate system Σb coincides with the Ya axis of the coordinate system Σa. A Zb axis of the coordinate system Σb corresponds to an axis that is obtained in a case where the Za axis of the coordinate system Σa is rotated. The coordinate system Σb defines a plane, which is obtained in a case where the imaginary plane S is rotated about only one axis, by an XbYb plane. Two hall elements in the related art have a configuration in which the detection surface of one hall element is parallel to the imaginary plane S and the detection surface of the other hall element is parallel to the second detection surface S2a shown in FIG. 9.

From the state shown in FIG. 9, as shown in FIG. 10, the coordinate system Σb is rotated about the Xb axis in the − (minus) direction by θ2 [°]. The coordinate system rotated by θ2 [°] is the coordinate system Σc. An Xc axis of the coordinate system Σc coincides with the Xb axis of the coordinate system Σb. A Yc axis of the coordinate system Σc corresponds to an axis that is obtained in a case where the Yb axis of the coordinate system Σb is rotated. A Zc axis of the coordinate system Σc corresponds to an axis that is obtained in a case where the Zb axis of the coordinate system Σb is rotated. The coordinate system Σc defines a plane, which is obtained in a case where the imaginary plane S is rotated about two axes, by an XcYc plane. This plane coincides with the second detection surface S2 of the second hall element H2.

As described above, the second detection surface S2 of the second hall element H2 is provided in parallel to the imaginary plane S that is obtained in a state where the imaginary plane S parallel to the first detection surface S1 of the first hall element H1 is rotated about a first axis (the Ya axis extending in the Y direction (first direction) of the coordinate system Σa) set in the imaginary plane S and a second axis (the Xb axis extending in the X direction (second direction) of the coordinate system Σb) set in the imaginary plane S.

That is, the second detection surface S2 of the second hall element H2 is defined by a coordinate system that is set in a case where the coordinate system defining the first detection surface S1 of the first hall element H1 is rotated about two axes. Each of θ1 and θ2 has a value less than 90°.

[As for Change in Magnetic Flux Density Detected by First Hall Element and Second Hall Element]

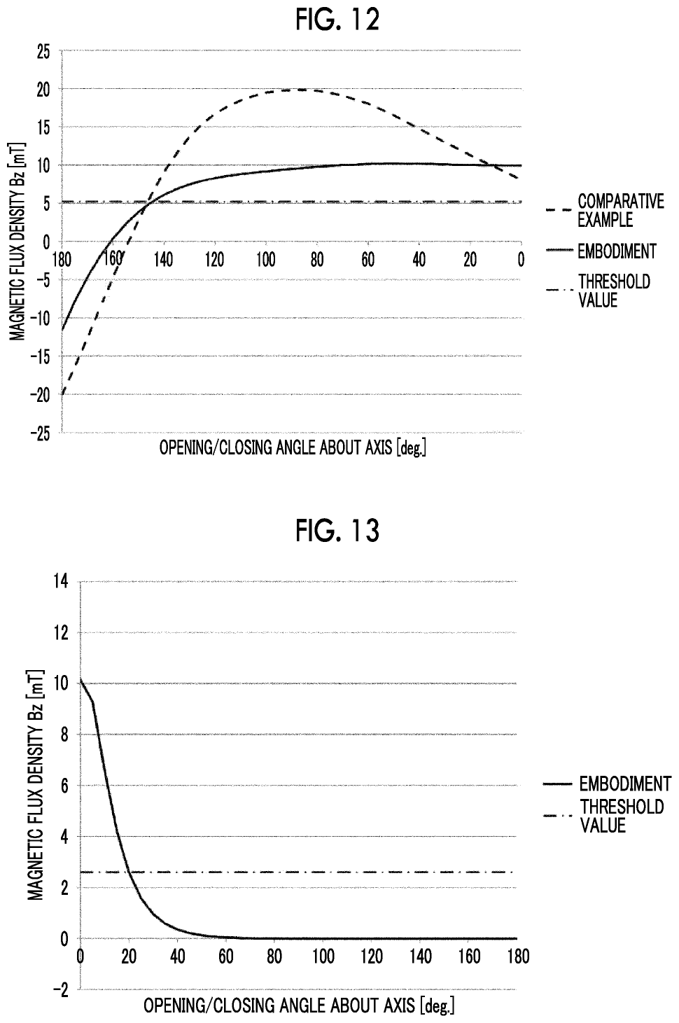

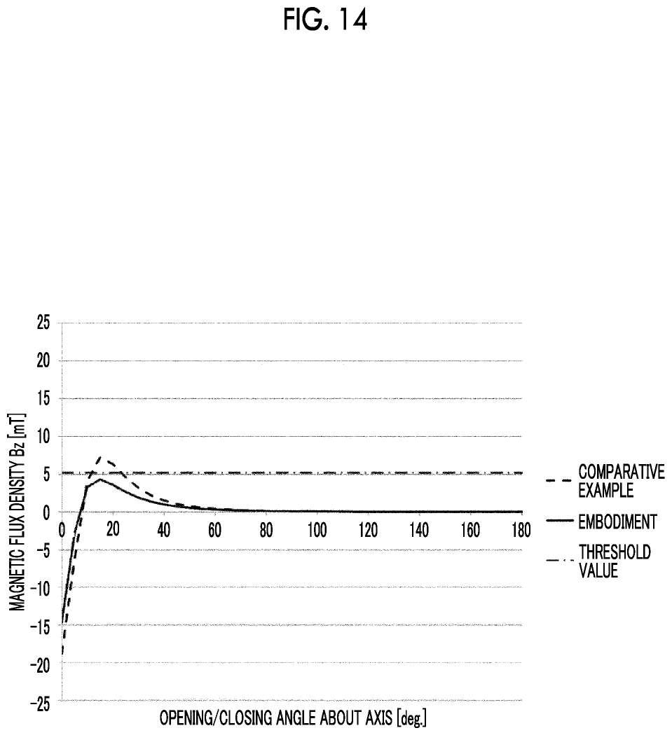

Next, a change in the magnetic flux densities detected by the first hall element H1 and the second hall element H2 will be described with reference to FIGS. 11 to 14. FIG. 11 is a graph illustrating a change in a magnetic flux density that is detected by the first hall element H1 in a case where the display unit 15 is rotationally moved to the first state from the second state. FIG. 12 is a graph illustrating a change in a magnetic flux density that is detected by the second hall element H2 in a case where the display unit 15 is rotationally moved to the first state from the second state. FIG. 13 is a graph illustrating a change in a magnetic flux density that is detected by the first hall element H1 in a case where the display unit 15 is rotationally moved to the third state from the second state. FIG. 14 is a graph illustrating a change in a magnetic flux density that is detected by the second hall element H2 in a case where the display unit 15 is rotationally moved to the third state from the second state.

Further, the embodiment and a comparative example (the related art) are compared with each other in FIGS. 11 to 14. The detection surface of a second hall element H2 of the comparative example has the configuration shown in FIG. 9, and coincides with a plane that is obtained in a case where the imaginary plane S is rotated about the Ya axis of the coordinate system Σa in the + (plus) direction by θ1 [°]. That is, the second detection surface S2 of the second hall element H2 of the comparative example is parallel to a plane that is obtained in a case where the imaginary plane S is rotated about only one axis. The second detection surface S2 of the second hall element H2 of the embodiment is parallel to a plane that is obtained in a case where the imaginary plane S is rotated about two axes. The orientation of the first detection surface S1 of the first hall element H1 in the embodiment is the same as that in the comparative example.

In FIGS. 12 and 14, the magnetic flux density detected by the second hall element H2 of the embodiment is shown by a solid line and the magnetic flux density detected by the second hall element H2 of the comparative example is shown by a dotted line. Further, since the graphs of the embodiment and the comparative example overlap with each other in FIGS. 11 and 13, the comparative example is not shown in FIGS. 11 and 13.

As shown in FIGS. 11 and 12, in a case where the display unit 15 is rotationally moved to the first state shown in FIG. 1 from the second state shown in FIG. 2, the magnetic flux densities detected by the first hall element H1 and the second hall element H2 are changed depending on an opening/closing angle about the first rotational axis J1. The horizontal axes of FIGS. 11 and 12 represent the opening/closing angle [°] of the display unit 15 about the first rotational axis J1. The vertical axes of FIGS. 11 and 12 represent the magnetic flux density [mT] detected by the first hall element H1 or the second hall element H2.

While the rotational movement state of the display unit 15 proceeds to the first state from the second state, the rotation angle of the display unit 15 about the second rotational axis J2 is maintained (fixed) at 0°. The opening/closing angle of the display unit 15 about the first rotational axis J1 is changed to 0° from 180° in this state where the rotation angle of the display unit 15 about the second rotational axis J2 is fixed. At this time, as shown in FIG. 11, the magnetic flux density detected by the first hall element H1 in the initial detection state (in a case where the opening/closing angle is 180°) is equal to or higher than the threshold value in both the embodiment and the comparative example. For this reason, in both the cases of the embodiment and the comparative example, the processor 14 determines that the detection state of a magnetic field detected by the first hall element H1 is an ON state. Further, as shown in FIG. 12, the magnetic flux density detected by the second hall element H2 in the initial detection state (in a case where the opening/closing angle is 180°) is equal to or lower than the threshold value in both the embodiment and the comparative example. For this reason, in both the cases of the embodiment and the comparative example, the processor 14 determines that the detection state of a magnetic field detected by the second hall element H2 is an OFF state. Accordingly, the processor 14 determines that the rotational movement state of the display unit 15 is the second state in a case where the detection state of a magnetic field detected by the first hall element H1 is an ON state and the detection state of a magnetic field detected by the second hall element H2 is an OFF state.

As the opening/closing angle of the display unit 15 about the first rotational axis J1 is reduced from 180° to 0°, the magnetic flux density detected by the first hall element H1 is changed at the same level in both the embodiment and the comparative example and is still equal to or higher than the threshold value as shown in FIG. 11. For this reason, in both the cases of the embodiment and the comparative example, the processor 14 determines that the detection state is an ON state as it is.

Further, as the opening/closing angle of the display unit 15 about the first rotational axis J1 is reduced from 180° to 0°, the magnetic flux density detected by the second hall element H2 exceeds the threshold value in both the embodiment and the comparative example at a point of time when the opening/closing angle is about 145° as shown in FIG. 12. After that, as the opening/closing angle is increased, the magnetic flux density detected by the second hall element H2 is increased and is in a steady state in the case of the embodiment and is increased to form a peak (gentle mountain) and then starts to be reduced in the case of the comparative example. However, the magnetic flux density detected by the second hall element H2 is equal to or higher than the threshold value in both the embodiment and the comparative example. For this reason, there is no difference in the detection state between the embodiment and the comparative example and the processor 14 switches the detection state from the OFF state to the ON state at a point of time when the opening/closing angle is about 145° in both the cases of the embodiment and the comparative example. Accordingly, the processor 14 can determine that the rotational movement state of the display unit 15 is the first state in a case where the detection state of a magnetic field detected by the first hall element H1 is an ON state and the detection state of a magnetic field detected by the second hall element H2 is an ON state.

As shown in FIGS. 13 and 14, in a case where the display unit 15 is rotationally moved to the third state shown in FIG. 3 from the second state shown in FIG. 2, the magnetic flux densities detected by the first hall element H1 and the second hall element H2 are changed depending on a rotation angle about the second rotational axis J2. The horizontal axes of FIGS. 13 and 14 represent the rotation angle [°] of the display unit 15 about the second rotational axis J2. The vertical axes of FIGS. 13 and 14 represent the magnetic flux density [mT] detected by the first hall element H1 or the second hall element H2.

While the rotational movement state of the display unit 15 proceeds to the third state from the second state, the opening/closing angle of the display unit 15 about the first rotational axis J1 is maintained (fixed) at 180°. The rotation angle of the display unit 15 about the second rotational axis J2 is changed to 180° from 0° in this state where the opening/closing angle of the display unit 15 about the first rotational axis J1 is fixed. At this time, as shown in FIG. 13, the magnetic flux density detected by the first hall element H1 in the initial detection state (in a case where the rotation angle is 0°) is equal to or higher than the threshold value in both the embodiment and the comparative example. For this reason, in both the cases of the embodiment and the comparative example, the processor 14 determines that the detection state of a magnetic field detected by the first hall element H1 is an ON state. Further, as shown in FIG. 14, the magnetic flux density detected by the second hall element H2 in the initial detection state (in a case where the rotation angle is 0°) is equal to or lower than the threshold value in both the embodiment and the comparative example. For this reason, in both the cases of the embodiment and the comparative example, the processor 14 determines that the detection state of a magnetic field detected by the second hall element H2 is an OFF state.

As the rotation angle of the display unit 15 about the second rotational axis J2 is increased from 0° to 180°, the magnetic flux density detected by the first hall element H1 is reduced in both the embodiment and the comparative example and is equal to or lower than the threshold value at a point of time when the rotation angle is about 20° as shown in FIG. 13. For this reason, in both the cases of the embodiment and the comparative example, the processor 14 switches the detection state to the OFF state from the ON state at a point of time when the rotation angle is about 20°.

Further, as the rotation angle of the display unit 15 about the second rotational axis J2 is increased from 0° to 180°, the magnetic flux density detected by the second hall element H2 is increased and then starts to be reduced and forms a peak (mountain) at a point of time when the rotation angle is about 20° in both the embodiment and the comparative example as shown in FIG. 14. Here, since the peak of the magnetic flux density of the embodiment is gentler than that of the comparative example and the level thereof is also lower than that of the comparative example, there is no moment at which the magnetic flux density exceeds the threshold value. Since the peak of the magnetic flux density of the comparative example is more suddenly changed than that of the embodiment and the level thereof is also higher than that of the embodiment, the comparative example has a moment at which the magnetic flux density exceeds the threshold value.

In a case where the rotational movement state of the display unit 15 proceeds to the third state from the second state, the magnetic flux density of a magnetic field, which is generated from the magnet M, detected by the third hall element H3 remains smaller than the threshold value. Accordingly, in a case where the detection state of a magnetic field detected by the first hall element H1 is an OFF state, the detection state of a magnetic field detected by the second hall element H2 is an OFF state, and the detection state of a magnetic field detected by the third hall element H3 is an OFF state, the processor 14 can determine that the rotational movement state of the display unit 15 is the third state.

In a case where the rotational movement state of the display unit 15 proceeds to the fourth state from the third state, the detection state of a magnetic field detected by the first hall element H1 is maintained in an OFF state and the detection state of a magnetic field detected by the second hall element H2 is maintained in an OFF state. However, in the fourth state, the magnetic flux density of a magnetic field, which is generated from the magnet M, detected by the third hall element H3 is equal to or higher than the threshold value. Accordingly, in a case where the detection state of a magnetic field detected by the third hall element H3 is an ON state, the processor 14 can determine that the rotational movement state of the display unit 15 is the fourth state.

Since the magnetic flux density detected by the second hall element H2 is equal to or lower than the threshold value in any range in the case of the embodiment in a case where the rotation angle of the display unit 15 about the second rotational axis J2 is increased from 0° to 180°, the processor 14 determines that the detection state of a magnetic field detected by the second hall element H2 is an OFF state. However, in the case of the comparative example, the magnetic flux density detected by the second hall element H2 momentarily exceeds the threshold value in a case where the rotation angle is about 15°. For this reason, since the processor 14 switches the detection state to an ON state from an OFF state at that point of time and then switches the detection state to an OFF state from an ON state again, there is a possibility that an erroneous determination is made.

That is, since the second detection surface S2 of the second hall element H2 is defined by a coordinate system rotated about two axes in the case of the embodiment, the detection state of the second hall element H2 is optimized and the erroneous determination of the rotational movement state of the display unit 15, which is to be made by the processor 14, is prevented. Specifically, it is possible to accurately determine whether or not the rotational movement state of the display unit 15 is the third state. Accordingly, it is possible to determine the rotational movement state of the display unit 15 with high accuracy.

The specific embodiment has been described above, but the present invention is not limited to the description of the embodiment and can be appropriately modified without departing from the scope of the present invention.

For example, the first hall element H1 and the second hall element H2 are fixed to the body part 11 and the magnet M is fixed to the display unit 15 in the embodiment, but the present invention is not limited thereto. For example, conversely, the first hall element H1 and the second hall element H2 may be fixed to the display unit 15 and the magnet M may be fixed to the body part 11.

Further, each of the first hall element H1, the second hall element H2, and the third hall element H3 has only to be an element that can detect a magnetic field, and may be, for example, a magneto resistive (MR) sensor or the like. The magnet M has only to be capable of generating a constant magnetic field, and may be an electromagnet without being limited to a permanent magnet.

The second detection surface S2 of the second hall element H2 may be parallel to a plane that is obtained in a case where the second detection surface S2a shown in FIG. 9 rotated about the Xb axis in the + direction by θ2. Further, the second detection surface S2 of the second hall element H2 may be parallel to a plane that is obtained in a case where the second detection surface S2a shown in FIG. 8 is rotated about the Ya axis in the − direction by θ1 and is further rotated about the Xb axis in the + direction or the − direction by θ2. In any case, it is possible to accurately determine which one of the first state, the second state, and the third state the rotational movement state of the display unit 15 is on the basis of the outputs of the first hall element H1 and the second hall element H2 by adjusting the orientation or the like of the magnetic field of the magnet M.

The followings are disclosed in this specification as described above. Corresponding components and the like of the above-mentioned embodiment are shown in parentheses, but the present invention is not limited thereto.

(1)

An electronic apparatus (imaging apparatus 10) comprising:

a body (body part 11);

a rotational movement member (display unit 15) that is rotationally movable with respect to the body in a first rotational movement direction (first rotational movement direction R1) about a first rotational axis (first rotational axis J1) and a second rotational movement direction (second rotational movement direction R2) about a second rotational axis (second rotational axis J2);

a magnetic field generator (magnet M);

a first magnetic field detection element (first hall element H1) that detects a magnetic field generated from the magnetic field generator;

a second magnetic field detection element (second hall element H2) that detects the magnetic field generated from the magnetic field generator; and

a processor (processor 14) that determines which one of a first state, a second state, and a third state a rotational movement state of the rotational movement member is on the basis of detection states of the magnetic field detected by the first magnetic field detection element and the second magnetic field detection element,

wherein in a state where an imaginary plane (imaginary plane S) parallel to a detection surface (first detection surface S1) of the first magnetic field detection element is rotated about a first axis (Ya axis) extending in a first direction (Y direction) and a second axis (Xb axis) extending in a second direction (X direction) intersecting with the first direction, a detection surface (second detection surface S2) of the second magnetic field detection element is parallel to the imaginary plane,

both of the first direction and the second direction are directions along the imaginary plane,

the first direction is an extending direction of the first rotational axis, and

the second direction is an extending direction of the second rotational axis.

(2)

The electronic apparatus according to (1),

wherein the first rotational axis and the second rotational axis are orthogonal to each other.

(3)

The electronic apparatus according to (2),

wherein a perpendicular line to the detection surface of the first magnetic field detection element is orthogonal to the first rotational axis and the second rotational axis.

(4)

The electronic apparatus according to any one of (1) to (3),

wherein the rotational movement member is provided with the magnetic field generator, and

the body is provided with the first magnetic field detection element and the second magnetic field detection element.

(5)

The electronic apparatus according to any one of (1) to (4),

wherein the first rotational movement direction is an opening/closing direction of the rotational movement member with respect to the body,

the second rotational movement direction is a rotation direction of the rotational movement member with respect to the body,

the first state is a state where the rotational movement member is closed with respect to the body,

the second state is a state where the rotational movement member is opened with respect to the body, and

the third state is a state where the rotational movement member is opened and rotated with respect to the body.

(6)

The electronic apparatus according to any one of (1) to (5),

wherein the rotational movement member is a display unit.

(7)

The electronic apparatus according to (6), further comprising:
an imaging element.

(8)

A method of determining a rotational movement state of a rotational movement member of an electronic apparatus (imaging apparatus 10) including a body (body part 11), the rotational movement member (display unit 15) that is rotationally movable with respect to the body in a first rotational movement direction (first rotational movement direction R1) about a first rotational axis (first rotational axis J1) and a second rotational movement direction (second rotational movement direction R2) about a second rotational axis (second rotational axis J2), a magnetic field generator (magnet M), a first magnetic field detection element (first hall element H1) that detects a magnetic field generated from the magnetic field generator, and a second magnetic field detection element (second hall element H2) that detects the magnetic field generated from the magnetic field generator,

wherein in a state where an imaginary plane (imaginary plane S) parallel to a detection surface (first detection surface S1) of the first magnetic field detection element is rotated about a first axis (Ya axis) extending in a first direction (Y direction) and a second axis (Xb axis) extending in a second direction (X direction) intersecting with the first direction, a detection surface (second detection surface S2) of the second magnetic field detection element is parallel to the imaginary plane,

both of the first direction and the second direction are directions along the imaginary plane,

the first direction is an extending direction of the first rotational axis,

the second direction is an extending direction of the second rotational axis, and

the method comprises determining which one of a first state, a second state, and a third state a rotational movement state of the rotational movement member is on the basis of detection states of the magnetic field detected by the first magnetic field detection element and the second magnetic field detection element.

(9)

The method of determining a rotational movement state according to (8),

wherein the first rotational axis and the second rotational axis are orthogonal to each other.

(10)

The method of determining a rotational movement state according to (9),

wherein a perpendicular line to the detection surface of the first magnetic field detection element is orthogonal to the first rotational axis and the second rotational axis.

(11)

The method of determining a rotational movement state according to any one of (8) to (10),

wherein the rotational movement member is provided with the magnetic field generator, and

the body is provided with the first magnetic field detection element and the second magnetic field detection element.

(12)

The method of determining a rotational movement state according to any one of (8) to (11),

wherein the first rotational movement direction is an opening/closing direction of the rotational movement member with respect to the body,

the second rotational movement direction is a rotation direction of the rotational movement member with respect to the body,

the first state is a state where the rotational movement member is closed with respect to the body,

the second state is a state where the rotational movement member is opened with respect to the body, and

the third state is a state where the rotational movement member is opened and rotated with respect to the body.

(13)

The method of determining a rotational movement state according to any one of (8) to (12),

wherein the rotational movement member is a display unit.

(14)

The method of determining a rotational movement state according to (13),

wherein the electronic apparatus is provided with an imaging element.

(15)

A program for determining a rotational movement state of a rotational movement member of an electronic apparatus including a body, the rotational movement member that is rotationally movable with respect to the body in a first rotational movement direction about a first rotational axis and a second rotational movement direction about a second rotational axis, a magnetic field generator, a first magnetic field detection element that detects a magnetic field generated from the magnetic field generator, and a second magnetic field detection element that detects the magnetic field generated from the magnetic field generator,

wherein in a state where an imaginary plane parallel to a detection surface of the first magnetic field detection element is rotated about a first axis extending in a first direction and a second axis extending in a second direction intersecting with the first direction, a detection surface of the second magnetic field detection element is parallel to the imaginary plane,

both of the first direction and the second direction are directions along the imaginary plane,

the first direction is an extending direction of the first rotational axis,

the second direction is an extending direction of the second rotational axis, and

the program causes a processor to perform a step of determining which one of a first state, a second state, and a third state a rotational movement state of the rotational movement member is on the basis of detection states of the magnetic field detected by the first magnetic field detection element and the second magnetic field detection element.

Various embodiments have been described above with reference to the drawings, but it goes without saying that the invention is not limited to the embodiments. Since it is apparent for those skilled in the art that various changes or modifications can be thought up within categories described in claims, it is naturally understood that these changes or modifications also pertain to the technical scope of the invention. Further, the respective components of the above-mentioned embodiments may be combined arbitrarily without departing from the scope of the invention.

This application is based on Japanese Patent Application (JP2020-024395) filed Feb. 17, 2020, the contents of which are incorporated herein by reference.

### EXPLANATION OF REFERENCES

10: imaging apparatus
11: body part
12: housing recessed portion
13: bottom surface
14: processor
15: display unit
16: display panel
17: finger hook portion
20: hinge unit
21: base part
22: side wall portion
23: connecting portion
24: first shaft part
25: first fixing plate part
26: second shaft part
27: second fixing plate part
H1: first hall element
H2: second hall element
H3: third hall element
J1: first rotational axis
J2: second rotational axis
M: magnet
Mn: left portion
Ms: right portion
R1: first rotational movement direction
R2: second rotational movement direction
S: imaginary plane
S1: first detection surface
S2: second detection surface
S2a: second detection surface

What is claimed is:

1. An electronic apparatus comprising:
a body;
a rotational movement member that is rotationally movable with respect to the body in a first rotational movement direction about a first rotational axis and a second rotational movement direction about a second rotational axis;
a magnetic field generator;
a first magnetic field detection element that detects a magnetic field generated from the magnetic field generator;
a second magnetic field detection element that detects the magnetic field generated from the magnetic field generator; and
a processor that determines which one of a first state, a second state, and a third state a rotational movement state of the rotational movement member is based on detection states of the magnetic field detected by the first magnetic field detection element and the second magnetic field detection element,
wherein in a state where an imaginary plane parallel to a detection surface of the first magnetic field detection element is rotated about a first axis extending in a first direction and a second axis extending in a second direction intersecting with the first direction, a detection surface of the second magnetic field detection element is parallel to the imaginary plane,
both of the first direction and the second direction are directions along the imaginary plane,
the first direction is an extending direction of the first rotational axis, and
the second direction is an extending direction of the second rotational axis.

2. The electronic apparatus according to claim 1,
wherein the first rotational axis and the second rotational axis are orthogonal to each other.

3. The electronic apparatus according to claim 2,
wherein a perpendicular line to the detection surface of the first magnetic field detection element is orthogonal to the first rotational axis and the second rotational axis.

4. The electronic apparatus according to claim 1,
wherein the rotational movement member is provided with the magnetic field generator, and
the body is provided with the first magnetic field detection element and the second magnetic field detection element.

5. The electronic apparatus according to claim 1,
wherein the first rotational movement direction is an opening/closing direction of the rotational movement member with respect to the body,
the second rotational movement direction is a rotation direction of the rotational movement member with respect to the body,
the first state is a state where the rotational movement member is closed with respect to the body,
the second state is a state where the rotational movement member is opened with respect to the body, and
the third state is a state where the rotational movement member is opened and rotated with respect to the body.

6. The electronic apparatus according to claim 1,
wherein the rotational movement member is a display unit.

7. The electronic apparatus according to claim 6, further comprising:
an imaging element.

8. A method of determining a rotational movement state of a rotational movement member of an electronic apparatus including a body, the rotational movement member that is rotationally movable with respect to the body in a first rotational movement direction about a first rotational axis and a second rotational movement direction about a second rotational axis, a magnetic field generator, a first magnetic field detection element that detects a magnetic field generated from the magnetic field generator, and a second magnetic field detection element that detects the magnetic field generated from the magnetic field generator,
wherein in a state where an imaginary plane parallel to a detection surface of the first magnetic field detection element is rotated about a first axis extending in a first direction and a second axis extending in a second direction intersecting with the first direction, a detection surface of the second magnetic field detection element is parallel to the imaginary plane,
both of the first direction and the second direction are directions along the imaginary plane,
the first direction is an extending direction of the first rotational axis,
the second direction is an extending direction of the second rotational axis, and
the method comprises determining which one of a first state, a second state, and a third state a rotational movement state of the rotational movement member is based on detection states of the magnetic field detected by the first magnetic field detection element and the second magnetic field detection element.

9. The method of determining a rotational movement state according to claim 8,
wherein the first rotational axis and the second rotational axis are orthogonal to each other.

10. The method of determining a rotational movement state according to claim 9,
wherein a perpendicular line to the detection surface of the first magnetic field detection element is orthogonal to the first rotational axis and the second rotational axis.

11. The method of determining a rotational movement state according to claim 8,
wherein the rotational movement member is provided with the magnetic field generator, and
the body is provided with the first magnetic field detection element and the second magnetic field detection element.

12. The method of determining a rotational movement state according to claim 8,
wherein the first rotational movement direction is an opening/closing direction of the rotational movement member with respect to the body,
the second rotational movement direction is a rotation direction of the rotational movement member with respect to the body,
the first state is a state where the rotational movement member is closed with respect to the body,
the second state is a state where the rotational movement member is opened with respect to the body, and
the third state is a state where the rotational movement member is opened and rotated with respect to the body.

13. The method of determining a rotational movement state according to claim 8,
wherein the rotational movement member is a display unit.

14. The method of determining a rotational movement state according to claim 13,
wherein the electronic apparatus is provided with an imaging element.

15. A non-transitory computer readable medium storing a program for determining a rotational movement state of a rotational movement member of an electronic apparatus including a body, the rotational movement member that is rotationally movable with respect to the body in a first rotational movement direction about a first rotational axis and a second rotational movement direction about a second rotational axis, a magnetic field generator, a first magnetic field detection element that detects a magnetic field generated from the magnetic field generator, and a second magnetic field detection element that detects the magnetic field generated from the magnetic field generator,
wherein in a state where an imaginary plane parallel to a detection surface of the first magnetic field detection element is rotated about a first axis extending in a first direction and a second axis extending in a second direction intersecting with the first direction, a detection surface of the second magnetic field detection element is parallel to the imaginary plane,
both of the first direction and the second direction are directions along the imaginary plane,
the first direction is an extending direction of the first rotational axis,
the second direction is an extending direction of the second rotational axis, and
the program causes a processor to perform a step of determining which one of a first state, a second state, and a third state a rotational movement state of the rotational movement member is based on detection states of the magnetic field detected by the first magnetic field detection element and the second magnetic field detection element.
